(19) United States
(12) Patent Application Publication
(10) Pub. No.: US 2007/0064536 A1
(43) Pub. Date: Mar. 22, 2007

(54) Ground information processing method, ground information processing system, and earth resources system

(76) Inventor: Tadahiko Ogawa, Hachioji-shi (JP)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(21) Appl. No.: 11/217,746

(22) Filed: Sep. 1, 2005

(51) Int. Cl. G01V 1/00

(52) U.S. Cl. 367/75

(57) ABSTRACT

By nondestructively detecting a condition of ground 3 to be surveyed by using surface wave exploration means 4, using data analysis means 5 to calculate an S-wave velocity structure of the ground based on data detected by the surface wave exploration means 4, identifying a soil phase distribution of the ground by using a soil phase criteria table that is preset about a correspondence between S-wave velocities and soil phases based on a calculated S-wave velocity structure, and identifying an N-value distribution of the ground by using an N-value conversion expression or an N-value conversion table that is preset about a correspondence between S-wave velocities and N-values, an absorbed/released unit heat quantity per unit thickness of the ground 3, which provides a parameter, is estimated on the basis of the soil phase distribution and the N-value distribution that are identified by using a heat quantity conversion table that is preset about a relationship between the soil phase and a heat quantity and a relationship between the N-values and a heat quantity.

### BACKGROUND OF THE INVENTION

1. Field of the Invention

The present invention relates to a ground information processing method, a ground information processing system, and an earth resources system.

2. Description of the Related Art

A heat pump system is known as one of earth resources systems, which are heat exchange systems for carrying out cooling and heating by utilizing ground heat, which is one of earth resources, as a heat source. In this system, heat is exchanged by providing a heat exchanger to a well bored into the ground and a heat pump and a fluid medium reservoir section on the ground and connecting these to each other with a pipeline to circulate the fluid medium between a ground level and an underground level. To design a heat exchange system, it is common to calculate loads of air conditioning, hot water supplying, and heating and, besides, determine a soil phase of ground, an earth temperature, a specific heat, a thermal conductivity, an underground water level, and an underground water flow rate so that quantities of heat absorbed into and released from the ground can be decided, thereby selecting a capacity of the heat pump.

Heat exchange systems are thus designed taking into account a variety of factors, among which the quantities of absorbed heat and released heat are important in system design. Therefore, conventionally, ground to be surveyed has been bored directly to grasp a soil phase distribution and an N-value distribution of the ground, thereby estimating values of parameters required in system design.

As ground exploration methods, on the other hand, besides destructive survey methods such as a boring survey, a non-destructive survey method is available for knowing a underground structure from how vibrations run through. As a non-destructive survey method, a surface wave exploration method and a micro-motion exploration method are known.

By the surface wave exploration method, a sidetrack is provided along which a plurality of vibration sensors, which provides vibration reception means, is evenly spaced linearly, vibrations are applied to a vibration application point that is separated by an offset distance from an end of this sidetrack, all wave motions (surface wave, direct wave, refracted wave, reflected wave, etc.) of generated elastic waves are received by the vibration sensors arranged along the sidetrack and stocked in storage means, and the surface waves are identified from among these stocked wave motions in a record to analyze an S-wave velocity structure, thereby estimating an underground structure.

The micro-motion exploration method has, as means for observing natural micro-motions of ground, micro-motion observation means that uses a circular array comprised of a plurality of micro-motion observation devices (seismometers and storage devices) evenly spaced on a circumference of a circle drawn on a surface of the earth and one micro-motion observation device arranged at a center of this circle. Besides the case of providing one circle, such cases may be possible where two, three, or four concentric circles are provided, whereby surface waves are extracted from a record of micro-motions observed by the micro-motion observation devices that make up the circular array and, from the extracted surface waves, a relationship between a frequency and a phase velocity is calculated, to analyze an underground S-wave velocity structure based on this calculation.

Since boring survey, which is one of the ground exploration methods, is limited to extraction of a local underground structure of a survey area for the purpose of using boring survey in design of a heat exchange system, the boring survey must be carried out a lot of times on the survey area and so takes a lot of time, costs, and labor to perform, so that it results in sketchy ground estimate often. Therefore, at a stage of boring a well in which a heat exchanger used in an earth resources system, which is a heat exchange system, is to be laid, a large error occurs between a quantity of absorbed/released heat per unit thickness (unit quantity of absorbed/released heat) of ground estimated in design and a quantity of absorbed/released heat per unit thickness (unit quantity of absorbed/released heat) obtained from an actual ground after an operation of system facilities, so that it is often necessary to modify a well boring depth, the number of wells, and heat quantity calculation, thus resulting in a prolonged work period.

If the surface wave exploration method or the micro-motion exploration method is used as the ground exploration method, it is possible to reduce time, costs, and labor to be spent in survey; on the other hand, however, from a viewpoint of need to quickly analyze detected data obtained from a survey target, it is necessary to post at a survey place a professional engineer having a skilled capability related to measurement, observation, and analysis. Further, potential personal differences of the professional engineers may cause fluctuations in quality and analysis result of the detected data among these professionals even at the same survey place. Further, if the number of survey places increases, the number of the professional engineers may not be enough, thereby giving rise to fluctuations in analysis accuracy and extra time required in analysis.

### SUMMARY OF THE INVENTION

It is an object of the present invention to provide a ground information processing method and a ground information processing system that can accurately and rapidly analyze ground information which is used in design of an earth resources system.

It is another object of the present invention to provide an earth resources system in which errors between a designed heat quantity and an actual heat quantity are minimized to extremely reduce changes in design and which can shorten a work period and reduce labor costs and accommodates a variety of types of ground.

To achieve these objects, a ground information processing method related to the present invention employs surface wave exploration means as means to nondestructively detect a condition of ground to be surveyed. Based on data detected by these surface wave exploration means, the present method analyzes an S-wave speed structure of ground and, based on this analyzed S-wave speed structure, derives a parameter required to design an earth resources system that utilizes ground heat of the ground as a heat source. Such a ground information processing method can detect the ground condition nondestructively and, therefore, can save on time, costs, and labor required in survey as compared to a method by means of boring survey and also estimate accurate ground information.

The ground information processing method related to the present invention stores the data detected by the surface wave exploration means and transmits the detected data thus stored to data analysis means for processing and analyzing the detected data, via an exploration communication section connected to the surface wave exploration means. In such a ground information processing method, data detected by the surface wave exploration means is processed in a lump by the data analysis means, thereby enabling improving an efficiency of data processing.

In the ground information processing method related to the present invention, the data analysis means stores detected data transmitted from the exploration communication section and performs quality evaluation on the detected data transmitted from the exploration communication section based on data quality evaluation standards (that comprise standard waveforms and standard F-K spectra) that are preset about magnitude of noise and a relationships between frequencies and phase velocities. In the ground information processing method related to the present invention, the data analysis means transmits via an analysis communication section to the surface wave exploration means description, as instruction data, to prompt resurvey of the ground if the detected data is of an improper quality and description to prompt ending of survey if the detected data is of a proper quality.

In such a ground information processing method, instruction data that reflects a result of processing by the data analysis means is fed back to the at-site surface wave exploration means. If the detected data is of an improper quality, description to prompt resurvey of the ground is transmitted to the surface wave exploration means, so that by performing resurvey as required, an accuracy of ground survey is improved. If the detected data is of a proper quality, on the other hand, description to prompt ending of survey is transmitted to the surface wave exploration means, so that useless survey can be avoided, thus enabling reducing survey time.

In the ground information processing method related to the present invention, the data analysis means calculates a frequency vs. phase velocity relationship curve based on detected data transmitted from the exploration communication section and, based on a result of this calculation, analyzes an S-wave velocity structure and, based on this S-wave velocity structure, identifies a soil phase distribution of the ground by using a soil phase criteria table that is preset about correspondence between S-wave velocities and soil phases and identifies an N-value distribution of the ground by using conversion means such as an N-value conversion expression, an N-value conversion table, etc. that is preset about correspondence between S-wave velocities and N-values.

That is, the data analysis means performs Fourier transform on detected data and calculates a surface wave phase velocity for each frequency, to identify a frequency vs. phase velocity relationship (which is expressed as a curve referred to as a variance curve) and, based on this relationship, analyze an S-wave velocity structure. A method analyzing the S-wave velocity structure is generally referred to as reverse analysis, by which a variance curve (observed variance curve) obtained from detected data and a variance curve (logical variance curve) logically calculated from an S-wave velocity structure (initial structure model) that is initially analyzed on a trial basis according to this observed variance curve are compared to each other, to modify the S-wave velocity structure until these two curves match well, which steps are repeated sequentially.

Besides this method, such a method may be used as to analyze an S-wave velocity structure in a simplified manner, by which the S-wave velocity structure is analyzed by utilizing surface wave propagation properties that surface wave velocities are nearly 90% of S-wave velocities and that a velocity of a surface wave at a certain frequency indicates a weighted average S-wave velocity calculated down to a depth that corresponds to about ½ of a wavelength of this surface wave (that varies with the frequency). It is thus possible to analyze an S-wave velocity structure by using detected data with a high accuracy and accurately identify a soil phase distribution and an N-value distribution.

In the ground information processing method related to the present invention, the data analysis means uses a heat quantity conversion table preset about a relationship between soil phases and heat quantities and a relationship between N-values and heat quantities, to estimate an absorbed/released unit heat quantity for each unit ground thickness, which provides a parameter, based on a soil phase distribution and an N-value distribution. It is thus possible to accurately estimate the absorbed/released unit heat quantity of the ground from the heat quantity conversion table based on the accurately identified soil phase distribution and N-value distribution.

In an earth resources system related to the present invention for exchanging heat by utilizing ground heat, system design is performed using an accurate absorbed/released unit heat quantity obtained by the above-described ground information processing method, so that errors between an absorbed/released unit heat quantity used in design and an absorbed/released unit heat quantity of actual ground that is obtained after system facilities are operated are reduced, thereby extremely reducing changes in design.

To achieve these objects and methods, the present invention proposes a ground information processing system that comprises surface wave exploration means for surveying a condition of ground nondestructively and data analysis means for analyzing an S-wave velocity structure of the ground based on detected data obtained by the surface wave exploration means and utilizing, as a heat source, ground heat of the ground based on the analyzed S-wave velocity structure.

In the ground information processing system related to the present invention, the data analysis means comprises an S-wave analysis section for analyzing an S-wave velocity structure from detected data obtained by the surface wave exploration means, a soil phase/N-value decision section for identifying a soil phase distribution and an N-value distribution of the ground based on an S-wave velocity structure analyzed by the S-wave analysis section, a heat quantity analysis section for estimating an absorbed/released unit heat quantity, which provides a parameter, from a soil phase distribution and an N-value distribution identified by the soil phase/N-value decision section, a data quality evaluation section for evaluating a quality of detected data obtained by the surface wave exploration means, an analysis storage section for storing at least one of detected data obtained by the surface wave exploration means, a result of analysis by the S-wave analysis section, a result of identification by the soil phase/N-value decision section, a result of estimate by the heat quantity analysis section, and a result of quality evaluation by the data quality evaluation section, and display means for displaying a result of analysis by the heat quantity analysis section.

In the ground information processing system related to the present invention, the surface wave exploration means comprises vibration application means for applying vibrations to ground, vibration reception means for receiving vibrations generated on the ground by this vibration application means, an exploration storage section for storing detected data about vibrations received by the vibration reception means, and an exploration communication section for transmitting detected data stored in the exploration storage section to the data analysis means and receiving data of an instruction which prompts resurvey and ending of survey, the instruction data being transmitted from the data analysis means.

In the ground information processing system related to the present invention, the data analysis means comprises an analysis communication section for receiving detected data transmitted via the exploration communication section from the surface wave exploration means and transmitting instruction data to the surface wave exploration means via the exploration communication section.

According to the present invention, by using the surface wave exploration means as means to nondestructively detect a ground condition to be surveyed, a condition of ground can be surveyed nondestructively, so that based on the data detected by this surface wave exploration means, an S-wave velocity structure of the ground can be calculated and, based on the calculated s-wave velocity structure, a necessary parameter to be used in design of an earth resources system which uses ground heat of the ground as a heat source can be derived by the data analysis means. It is thus possible to save on time, costs, and labor required in survey as compared to the case of boring survey and also accurately estimate ground information to be used in design of the earth resources system.

According to the present invention, data detected by the surface wave exploration means is transmitted, via the exploration communication section connected to the surface wave exploration means, to the data analysis means that processes and analyzes the detected data, so that this detected data can be processed in a lump by the data analysis means, thereby improving an efficiency in data processing.

According to the present invention, a quality of detected data transmitted from the exploration communication section is evaluated on the basis of the data quality evaluation standards that are preset about relationships with magnitude of noise, a frequency, and a phase velocity, so that the quality of the detected data can be improved.

According to the present invention, if detected data is of an improper quality, description to prompt resurvey of ground is transmitted via the analysis communication section to the surface wave exploration means and if the detected data is of a proper quality, description to prompt ending of survey is done so, so that data of an instruction that reflects a result of analysis by the data analysis means is fed back to the at-site surface wave exploration means. If detected data of an improper quality, description to prompt resurvey of ground is transmitted to the surface wave exploration means, so that resurvey can be performed as required to improve accuracy of ground survey, and if the detected data is of a proper quality, description to prompt ending of survey of the ground is transmitted to the surface wave exploration means, so that useless survey can be avoided, thereby reducing survey time.

According to the present invention, a frequency vs. phase velocity relationship curve is calculated on the basis of detected data and, based on a result of this calculation, an S-wave velocity structure is analyzed and, based on this S-wave velocity structure, a soil phase distribution of the ground is identified by using the soil phase criteria table that is preset about correspondence between S-wave velocities and soil phases and an N-value distribution of the ground is identified by using the N-value conversion expression or the N-value conversion table that is preset about correspondence between S-wave velocities and N-values, so that it is possible to analyze the S-wave velocity structure by using accurate detected data and also accurately identify a soil phase distribution and an N-value distribution. Further, by using these identified soil phase distribution and N-value distribution, it is possible to accurately estimate an absorbed/released unit heat quantity for each unit ground thickness, which provides a parameter, according to the heat quantity conversion table preset about a relationship between soil phases and heat quantities and a relationship between N-values and heat quantities. Further, since at least a result of analysis by the neat quantity analysis section is displayed on the display means, the analysis result can be judged visually.

In the earth resources system related to the present invention for exchanging heat by utilizing ground heat, system design is performed using an accurate absorbed/released unit heat quantity obtained by the above-described ground information processing method, so that errors between an absorbed/released unit heat quantity used in design and an absorbed/released unit heat quantity of actual ground that is obtained after system facilities are operated are reduced, to extremely reduce changes in design, thereby performing system design that accommodates the ground while reducing a work period and labor costs.

### BRIEF DESCRIPTION OF THE DRAWINGS

FIG. 1 shows an outlined configuration of a ground information processing system that uses surface wave exploration means;

FIG. 2 shows one example of wave data displayed at an exploration storage section;

FIG. 3 shows a relationship between a variance curve and an S-wave velocity structure;

FIG. 4 shows one example of a soil phase criteria table to identify a soil phase from an S-wave velocity;

FIG. 5 shows one example of an N-value conversion table to identify an N-value from an S-wave velocity;

FIG. 6 shows one example of a heat quantity conversion table to derive an absorbed/released unit heat quantity for each unit ground thickness derived from an N-value distribution and a soil phase distribution;

FIG. 7 is a flowchart that shows a flow of data processing by a parameter processing section in data processing means;

FIG. 8 is a flowchart that shows a flow of data processing following a portion (1) in FIG. 7;

FIG. 9 is a flowchart that shows a flow of data processing by a quality decision processing section in data processing means;

FIG. 10 shows a configuration and a heated condition of a heat pump system, which is one embodiment of an earth resources system; and

FIG. 11 shows a condition in which the heat pump system of FIG. 10 is cooled.

### DESCRIPTION OF THE PREFERRED EMBODIMENTS

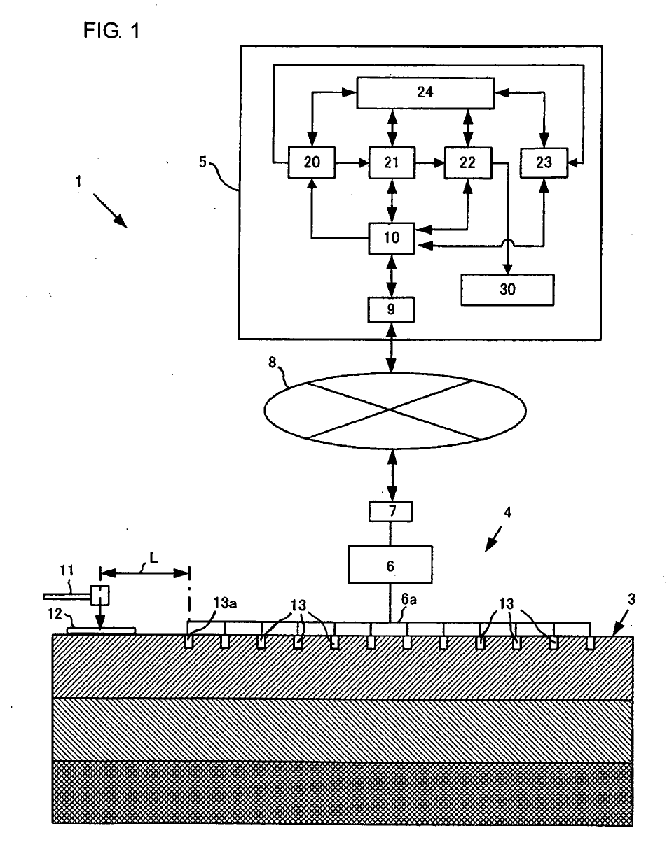

The following will describe embodiments of the present invention with reference to drawings. A ground information processing system 1 shown in FIG. 1 uses surface wave exploration means 4 as means to nondestructively detect an internal condition of ground 3 to be surveyed. The ground information processing system 1 comprises the surface wave exploration means 4 and data analysis means 5 for analyzing an S-wave velocity structure of the ground 3 based on data detected by the surface wave exploration means 4 and deriving a parameter required in design of a later-described earth resources system that utilizes, as a heat source, ground heat of the ground 3 based on this S-wave velocity structure.

The surface wave exploration means 4 comprises an exploration storage section 6 that stores detected data and has a display function and an exploration communication section 7 for transmitting detected data stored in the exploration storage section 6 to data analysis means 5 and receiving data of an instruction to prompt resurvey and ending of survey which is transmitted from the data analysis means 5. The exploration communication section 7 and the data analysis means 5 are connected to the Internet, which is one aspect of a network, so that they can exchange messages.

The surface wave exploration means 4 comprises a hammer 11 as vibration application means, an iron plate 12 that makes up a vibration application point when arranged on the ground 3 and hit by the hammer 11, a plurality of vibration reception sensors as vibration reception means that make up a vibration reception point, etc. The vibration reception sensors 13 are arranged linearly with a predetermined spacing (e.g., 0.5-2.0 m) between them and connected to the exploration storage section 6 with a cable 6a. The iron plate 12 whose part provides a vibration application point when hit by the hammer 11 is arranged on the same line as a row of the vibration reception sensors 13 in such a manner that this iron plate may be separate by an offset distance L from a nearest vibration reception sensor 13a. The offset distance L is 2-30 m typically. Although a member which is hit by the hammer 11 is the iron plate 12 in the present embodiment, a hard resin or the like may be used instead.

The surface wave exploration means 4 vibrates the ground 3 by hitting the iron plate 12 with the hammer 11, receives at the vibration reception sensors 13 all of generated elastic wave motions (surface waves, direct waves, refracted waves, and reflected waves), and stores them in the exploration storage section 6. The exploration storage section 6 stores wave motion data, which is detected data of vibrations received by the vibration reception sensors 13, and displays as waveform data to be displayed on the basis of data at the time of arrival wave propagation properties that reflect an underground structure below a point where the vibrations are received and also stores detected data about the received vibrations, depending on a purpose such as indication on a display not shown.

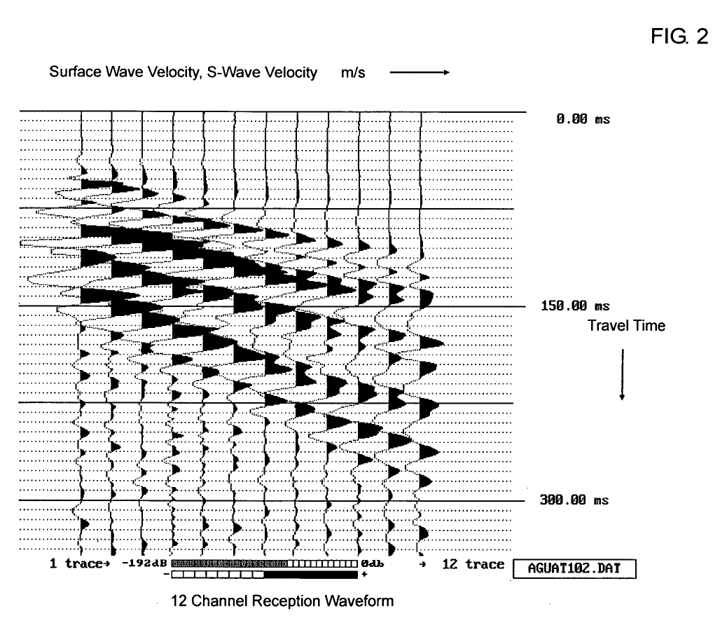

The spacing between the vibration reception sensors 13 and the distance of the offset L are properly established in order to obtain optimal waveform data (detected data) that accommodates properties of the ground 3 and not limited to specific values. FIG. 2 shows a record of waveforms at the time when data detected by the vibration reception sensors 13 placed on the ground 3 is stored.

The data analysis means 5 is a known computer comprised of an arithmetic circuit, a memory, etc. and equipped with a monitor, not shown, that serves as display means, a keyboard and a mouse that serve as operation means, etc. As shown in FIG. 1, the data analysis means 5 comprises an analysis communication section 9 that can transmit detected data to and receive it from the exploration communication section 7 in the surface wave exploration means 4, an analysis storage section 10 for storing a variety of kinds of information on the side of the data analysis means 5, an S-wave analysis section 20 for analyzing an S-wave velocity structure according to detected data obtained by the surface wave exploration means 4, a soil phase/N-value decision section 21 for identifying a soil phase distribution and an N-value distribution of ground according to an S-wave velocity structure analyzed by the S-wave analysis section 20, a heat quantity analysis section 22 for estimating an absorbed/released unit heat quantity, which provides a parameter, according to a soil phase distribution and an N-value distribution identified by the soil phase/N-value decision section 21, a data quality evaluation section 23 for evaluating a quality of detected data obtained by the surface wave exploration means 4, and display means 30 for displaying a result of analysis by the heat quantity analysis section 22. The data analysis means 5 can access the Internet 8 via the analysis communication section 9 and is configured so that it can transmit data and receive it from the exploration communication section 7.

In the present embodiment, the analysis storage section 10 is configured to store detected data transmitted from the exploration communication section 7 in the surface wave exploration means 4 and received by the analysis communication section 9, a result of analysis by the S-wave analysis section 20, a result of identification by the soil phase/N-value decision section 21, a result of estimate by the heat quantity analysis section 22, and a result of quality evaluation by the data quality evaluation section 23.

The data analysis means 5 has a function to transmit as indication data a result of evaluation on detected data performed by the data quality evaluation section 23 according to the data quality evaluation standards to the exploration communication section 7 via the analysis communication section 9. If detected data is decided to be of an improper quality by the data quality evaluation section 23, the data analysis means 5 has a function to transmit, as instruction data, description to prompt resurvey of target ground from the analysis communication section 9 via the exploration communication section 7 to the surface wave exploration means 4 and, if the detected data is of a proper quality, transmit description to prompt ending of survey of the target ground in the same manner.

The quality of detected data refers to a quality of data that is obtained according to whether a layout of the vibration reception sensors 13 is proper or not. Waveform data obtained through detection varies with whether an orientation or a position of each of the arranged vibration reception sensors 13 is proper or not. Further, if the ground 3 to be surveyed has in its periphery a noise source such as work of civil engineering and construction or passage of a heavy vehicle, waveform data obtained through detection is improper, in which case a measurement time zone must be changed to resurvey the ground. In the present embodiment, therefore, as the data quality evaluation standards, patterns of the waveform data obtained when the layout of the vibration reception sensors 13 is proper and not are typified into shapes of standard waveforms and standard F-K spectra and stored as a database in storage means 24 arranged in the data analysis means 5.

In the storage means 24, an initial structure model that accommodates an observed variance curve is stored as a database. This initial structure model is configured in such a manner that it may be selected and set automatically when an observed variance curve is identified. In the S-wave analysis section 20, a predetermined reference value is set with respect to a degree of coincidence between an observed variance curve and a logical separate curve so that until this reference value is reached, an attempt to analyze an S-wave velocity structure may be repeated. This reference value, typically near 1.000, is determined (e.g., 0.935, 0.950, or 0.980) according to the ground 3 to be surveyed and set when the value is entered on the keyboard not shown.

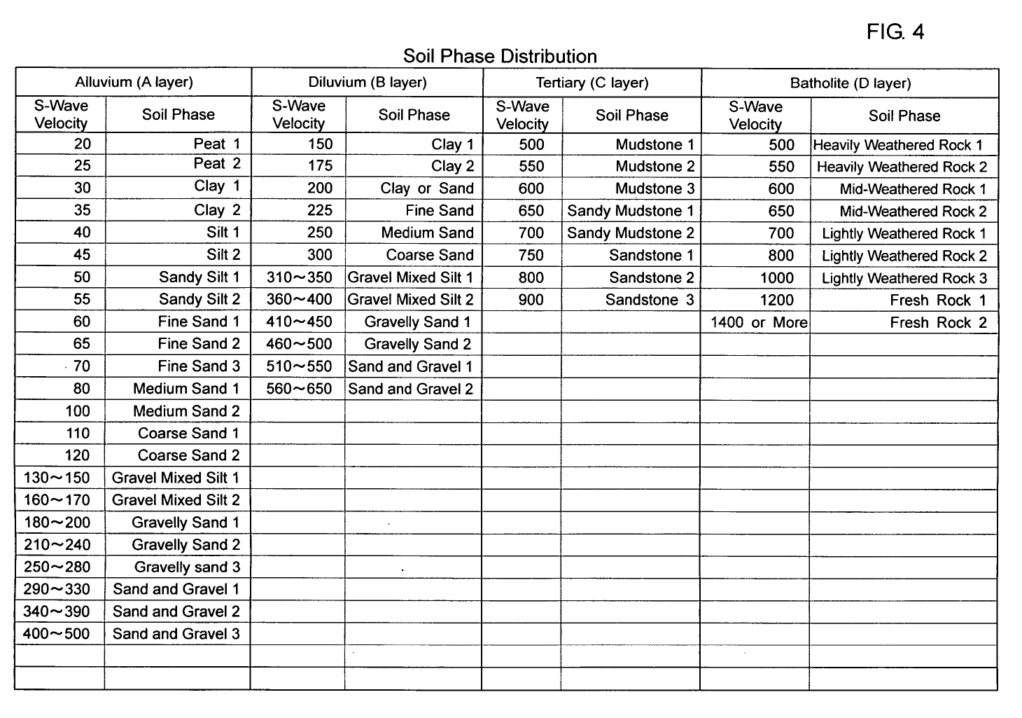

The soil phase/N-value decision section 21 is provided to identify a soil phase from such a soil phase criteria table as shown in FIG. 4 given as a database to identify soil phases from S-wave velocities. The soil phase criteria table is stored as a database in the storage means 24. Generally, soil phases of the ground 3 are multifarious, so that S-wave velocities are all different with the different soil phases. For example, in ground of the alluvial epoch (geologic age name), the S-wave velocity varies with whether a soil type is fine grain sand or course grain sand, silt or sand-mixed silt, clay or sand-mixed clay, and gravel or not, and whether the gravel has a larger gravel fraction or not, larger or not, and hard or small; moreover, even with the same soil type, the S-wave velocity varies with whether the soil's geological age is the alluvial epoch, the older diluvial epoch, or the tertiary period. Furthermore, in a case where the ground is a rock bed, the S-wave velocity varies with whether its lithofecies is of heavily weathered rock or lightly weathered rock. Further, the correspondence between the S-wave velocities and the soil phases varies with area features; this correspondence between the S-wave velocities and the soil phases varies with whether the area features are of a soft ground area, an alluvial fan dumping area, a river terrace, or a volcano mountain base. The soil type criteria table shown in FIG. 4 specifically and comprehensively summarizes the S-wave velocities that accommodate such a variety of soil phases and lithofecies.

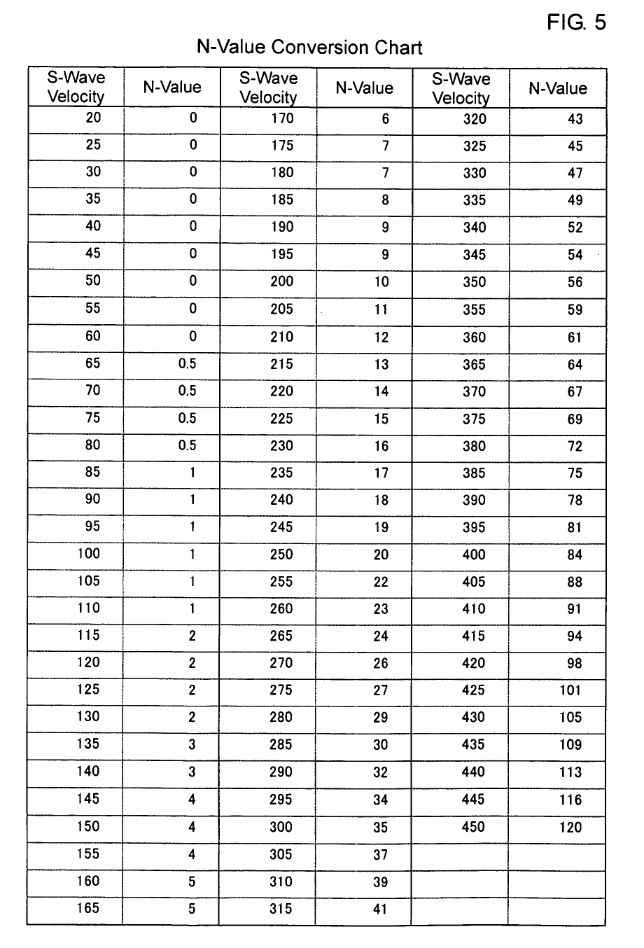

The soil phase/N-value decision section 21 is provided to identify an N-value by using conversion means such as a known N-value conversion expression to identify n-values from S-wave velocities or an N-value conversion table shown in FIG. 5. As the known N-value conversion table, for example, an expression of (S-wave velocity/91)^{2.97} may be enumerated. However, this expression is an average statistical expression that is calculated taking into account no soil phase diversity nor area features and created by omitting a job to properly correct a conversion method according to different soil phases and, therefore, limited in terms of accuracy when applied to all possible types of ground. The N-value conversion expression and the N-value conversion table are created on the basis of databases that are built according to a lot of measured data of surface wave exploration on a variety of soil phases in a variety of areas and have such features that an N-value can be identified highly accurately from an S-wave velocity and is stored in the storage means 24.

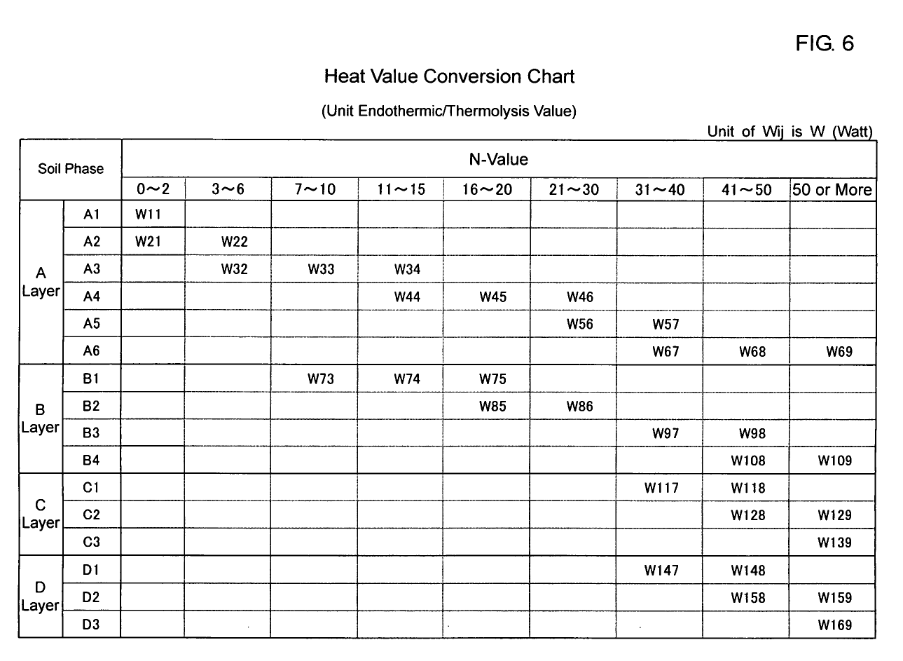

The heat quantity analysis section 22 is provided to estimate an absorbed/released unit heat quantity per unit ground thickness derived from an N-value distribution and a soil phase distribution, according to a heat quantity conversion table shown in FIG. 6, which is provided as a database. The heat conversion table is stored as the database in the storage means 24.

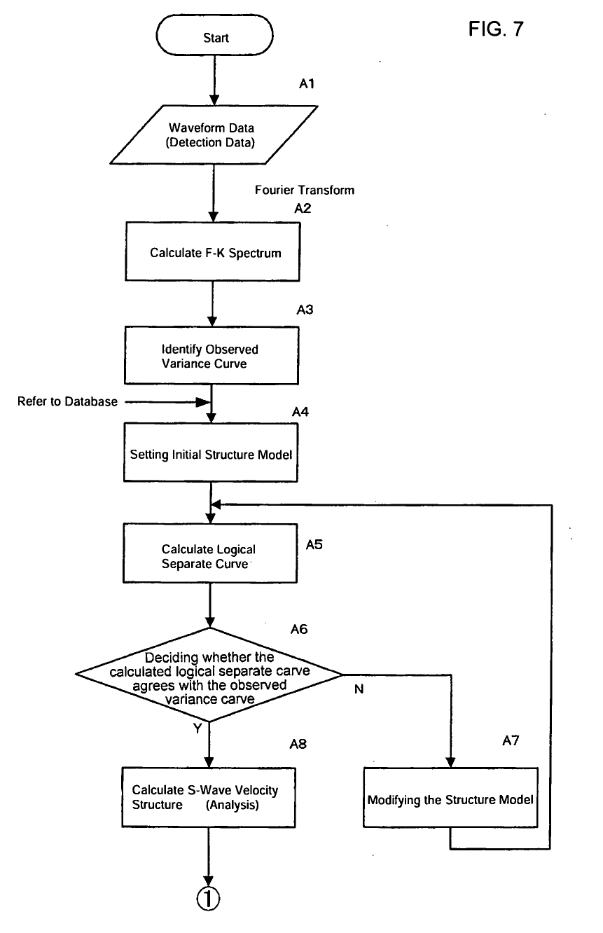

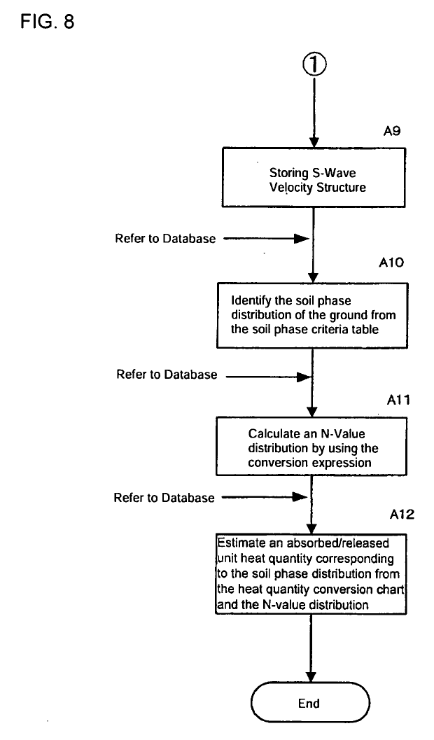

The following will describe a flow of processing by the data analysis means 5 with reference to flowcharts of FIGS. 7 and 8. Although FIGS. 7 and 8 are of the same flow, they are separated from each other at a portion (1) for convenience. Processing from steps A2-A8 of FIG. 7 shows a flow by the s-wave analysis section 20. At step A1, detected data (waveform data) is input, and at steps A2 and A3 an F-K spectrum is calculated, followed by identification of an observed variance curve shown by a dotted line in FIG. 2.

At step A4, the process sets an initial structure model by referencing the database stored in the storage means 24. At step A5, the process calculates a logical separate curve shown by a solid line in FIG. 2 from the set initial structure model according to the surface wave theory and goes to step A6. At step A6, the process decides whether the calculated logical separate curve agrees with the observed variance curve calculated at step A3 based on comparison to a target reference value. Given the natures of an observed value and a logical value, they rarely agree in the first place; therefore, if they do not agree, the process goes to step A7 to modify the structure model so that the logical separate curve may come close to the observed variance curve and returns to step A5 to calculate a logical separate curve again.

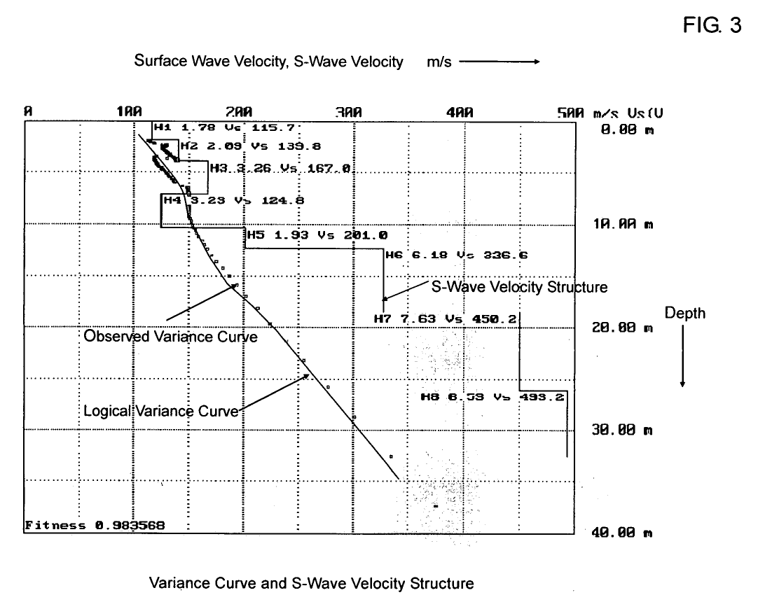

These steps A5-A7 are repeated until the logical separate curve and the observed variance curve agree. At step A6, if a degree of coincidence between the logical separate curve and the observed variance curve reaches the target reference value, the process goes to step A8 to analyze an S-wave velocity structure. A relationship between the S-wave velocity structure and the variance curve is shown in FIG. 3. In FIG. 3, a vertical axis represents a depth and a horizontal axis represents a phase velocity and an S-wave velocity of a surface wave.

Next, after analyzing the s-wave velocity structure at step A8, the process goes to step A9 of FIG. 8 to take in the analyzed s-wave velocity structure by storing it in the analysis storage section 10 and goes to step A10 to identify a soil phase distribution of the ground 3 from the soil phase criteria table shown in FIG. 4 and the S-wave velocity structure stored in the analysis storage section 10 according to the S-wave velocity structures provided as the database and stores a result of this identification in the analysis storage section 10 once.

At step A11, the process calculates an N-value distribution by using the S-wave velocity structure and the N-value conversion expression and stores a calculated value in the analysis storage section 10. It is to be noted that in place of the N-value conversion expression, the N-value conversion table shown in FIG. 5 may be used to select and identify the N-value distribution. These steps A9-A11 are processed by the soil phase/N-value decision section 21.

At step A12, the process causes the heat quantity analysis section 23 to estimate an absorbed/released unit heat quantity (which is a parameter used in design of an earth resources system) per unit thickness of the ground by referencing the heat quantity conversion table shown in FIG. 6 which is given as a database corresponding to the N-value distribution and the soil phase distribution which are stored in the storage means 24 and stores an estimated value in the analysis storage section 10 and then ends this series of processing.

It is thus possible to calculate an S-wave velocity structure of the ground 3 based on waveform data detected by the surface wave exploration means 4 and, based on the calculated S-wave velocity structure, derive (estimate) by using the data processing means 5 an absorbed/released unit heat quantity per unit thickness of the ground 3, which is a parameter necessary in design of an earth resources system which uses underground heat of the ground 3, and also to perform all the steps from collection of detected data to estimate of the absorbed/released unit heat quantity in a nondestructive job. Therefore, it is possible to save on time, costs, and labor of survey as compared to a case of using a destructive ground survey method such as boring survey and to accurately estimate ground information, which is indispensable for design of earth resources systems.

Since the waveform data detected by the surface wave exploration means 4 and stored in the exploration storage section 6 is transmitted to the data processing means 5 via the exploration communication section 7 connected to the exploration storage section 6, the waveform data from the surface wave exploration means 4 can be processed in a lump by the data processing means 5, thereby shortening data processing time and reducing fluctuations in result of analysis of the ground information and personnel for the analysis.

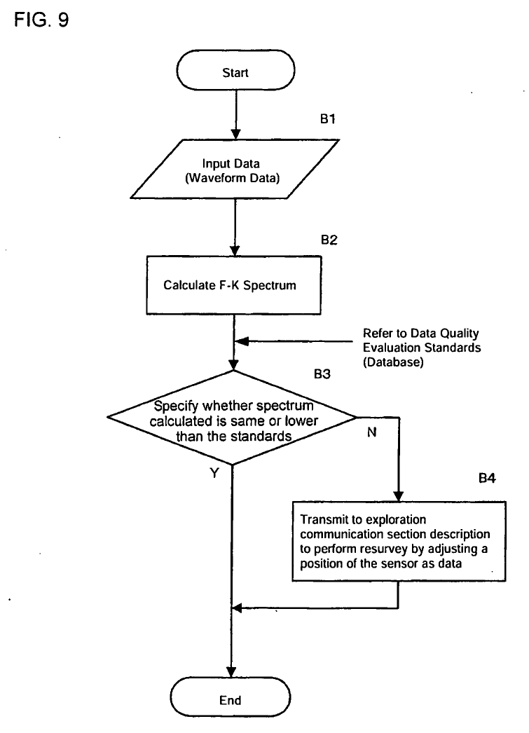

The following will describe processing by the data quality evaluation section 23 with reference to a flowchart of FIG. 9. At step B1, detected data is input from the analysis storage section 10 and, at step B2, a waveform and an F-K spectrum calculated by the S-wave analysis section 20 are displayed at a display device 30 such as a display. At step B3, the process evaluates a quality of the detected data in comparison to the data quality evaluation standards database and these waveform and F-K spectrum. In the present embodiment, the data is decided to be proper or improper in comparison to the standard waveform and standard F-K spectra that are provided as a database. A result of this decision is also displayed at the display device 30.

At step B3, if a waveform and an F-K spectrum satisfy the standards (i.e., if the data is proper), the process stores these waveform and F-K spectrum in the analysis storage section 10 and ends this processing and, if the waveform and the F-K spectrum do not satisfy the standards (i.e., if the data is improper), goes to step B4. At step B4, the process transmits to the exploration communication section 7 description to perform resurvey by, for example, shifting an orientation and a position or a measurement time zone of each of the vibration sensors 13.

In such a manner, if detected waveform data transmitted from the surface wave exploration means 4 is of an improper quality, the data quality evaluation section 23 in the data analysis means 5 transmits to the exploration communication section 6 description to prompt resurvey of the target ground 3 by the surface wave exploration means 4, so that it is possible to perform resurvey rapidly and improve an accuracy of survey on the target ground 3 as well as an accuracy of waveform data, which provides basis data for calculation of a parameter, thereby estimating the parameter more accurately. Further, a result of analysis is displayed at the display device 30 and so can be decided visually.

Although in the present embodiment initial structure models that correspond to the data quality evaluation standards, the soil phase criteria table, the N-value conversion expression, the N-value conversion table, the heat quantity conversion table, and the observed variance curve have been stored beforehand as a database in the common storage means 24, the storage means may be connected to each of the s-wave analysis section 20, the soil phase/N-value decision section 21, the heat quantity analysis section 22, and the data quality evaluation section 23 so that each of the storage means may store, as a database, information used in each of the sections.

Although in the present embodiment the vibration reception sensors 13 have been arranged along the same straight line, the present invention is not limited to it; they may be shifted to the right and left with respect to the same straight line in arrangement. Although the hammer 11 has been exemplified as the vibration application means, a firework or a known vibrator may be used as the vibration application means. If the vibrator is used, preferably its oscillation frequency can be controlled. Further, as the exploration method, an S-wave refractive exploration method by means of so-called plate hitting may be used.

Although the present embodiment has used the surface wave exploration means 4 as means to detect an internal condition of the ground 3, the present invention is not limited to it; a micro-motion exploration method encompassed by the surface wave exploration method in a broad sense may be used. In this case also, an s-wave velocity structure itself can be analyzed by an analysis method unique to the micro-motion exploration method, so that it is possible to derive, by using the data processing means 5, an absorbed/released unit heat quantity per unit thickness of the ground 3 by using the analyzed s-wave velocity structure and FIGS. 4, 5, and 6. Data thus derived could be displayed at the display means 30.

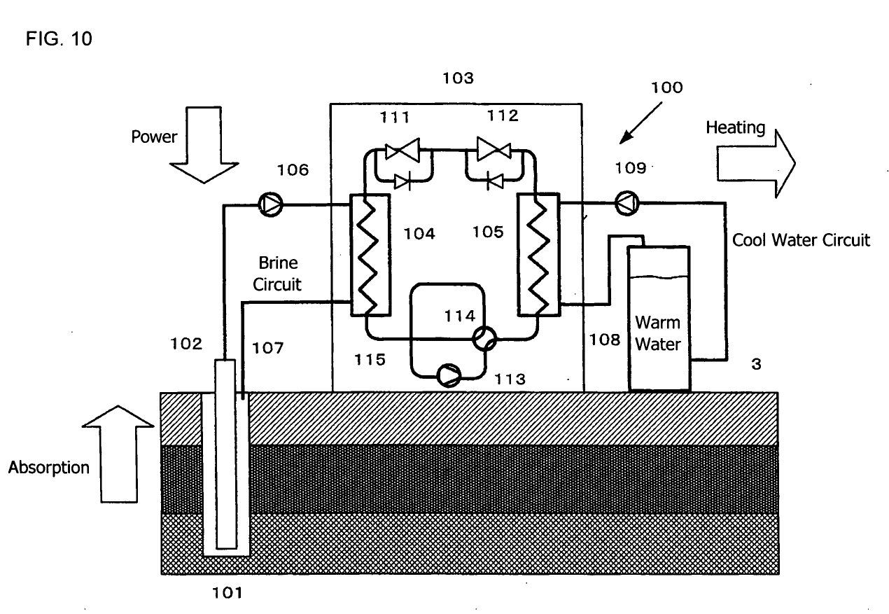

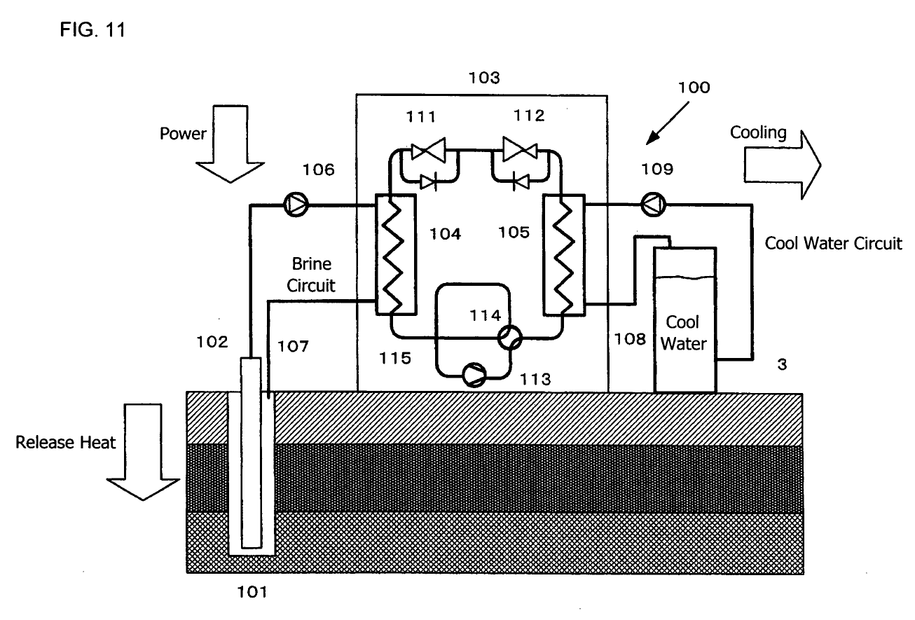

FIGS. 10 and 11 show an outlined configuration of a heat pump system 100, which is one example of an earth resources system, which is a heat exchange system that utilizes ground heat. FIG. 10 shows a condition where it is heated and FIG. 11, a condition where it is cooled.

The heat pump system 100 comprises a well 101 bored into ground 3 (subsurface) where this system is installed, a subsurface heat exchange section made up of a subsurface hear exchanger 102 mounted in the well 101, a heat pump 103 connected to the subsurface heat exchanger 102 and installed on an earth surface, a brine circuit 107 that is connected between an heat exchanger 104 on the condensation side of the heat pump 103 and the subsurface hear exchanger 102 and has a pump 106 to circulate a mixed solution, which serves as a fluid medium, of water and an anti-freeze liquid between the heat exchanger 104 and the subsurface hear exchanger 102, a cool/warm water tank 108 serving as stock means for stocking the mixed solution, and a circuit 110 that is connected between a heat exchanger 105 on the evaporation side of the heat pump 103 and the cool/warm water tank 108 and has a pump 109 to circulate the mixed solution in the cool/warm water tank 108 between the hear exchanger 105 and the cool/warm tank 108. In the heat pump 103, the heat exchangers 104 and 105 are provided on a cooling medium circuit 115 that is comprised of expansion valves 11 and 112, a compressor 113, and a reversing valve 114.

To design such a heat pump system 100, it is common to calculate loads of air conditioning, hot water supplying, and heating, select a capacity of the heat pump, and calculate absorbed/released heat quantities of the ground. In the heat pump system 100 used in the present embodiment, in such design, highly accurate absorbed/released unit heat quantities obtained by the ground information processing system 1 are used, so that errors are reduced between absorbed/released unit heat quantities (absorbed heat quantity/released heat quantity) calculated in design and those obtained from the ground 3 after the system facilities are operated, thereby extremely reducing changes in design. It is thus possible to avoid postponement of a work period owing to the changes in design of the system, thereby shortening the work period and accommodating a variety of types of ground in system design while reducing labor costs. Owing to the extreme reduction in changes in system design, it is possible to design and enforce the system inexpensively.

In the heat pump system 100 having such a configuration, when it is heated, a fluid medium absorbs ground heat by means of the subsurface heat exchanger 102 in the well 101 and, when it is cooled, the heat of the fluid medium is released underground by the subsurface heat exchanger 102. Absorption and releasing of the heat is thus performed underground, to enable greatly mitigating the heat island phenomenon and reducing power consumed in the heat pump system 100, thereby contributing to reduction of carbon dioxide. Further, the subsurface temperature is substantially constant all year round, so that these effects can be effected stably.

Although in the present embodiment the exemplified heat pump system 100 has had one well 101 and one subsurface heat exchanger 102, the present invention is not limited to it; the depth and the number of the wells 101 can be designed so that the heat can be picked up efficiently to obtain desired power properly, based on highly accurate data of absorbed/released heat quantities obtained by the ground information processing system 1.

What is claimed is:

1. A ground information processing method comprising the steps of nondestructively surveying a condition of ground to be surveyed, by using surface wave exploration means; analyzing an S-wave velocity structure of the ground based on data detected by the surface wave exploration means; and deriving a parameter required to design an earth resources system that uses ground heat of the ground as a heat source, based on the analyzed S-wave velocity structure, wherein:
the surface wave exploration means stores the detected data and transmits the stored detected data to data analysis means that processes and analyzes the detected data through an exploration communication section connected to the surface wave exploration means; and
the data analysis means calculates a frequency vs. phase velocity relationship curve based on the detected data transmitted from the exploration communication section and, based on a result of this calculation, analyzes the S-wave velocity structure and, based on the S-wave velocity structure, identifies a soil phase distribution of the ground by using a soil phase criteria table that is preset about correspondence between S-wave velocities and soil phases and identifies an N-value distribution of the ground by using an N-value conversion expression or an N-value conversion table that is preset about correspondence between the S-wave velocity and the N-value and, based on the soil phase distribution and the N-value distribution, estimates an absorbed/released unit heat quantity per unit thickness of the ground, which provides the parameter, by using a heat quantity conversion table that is preset about identified relationship between soil phases and heat quantities and relationship between N-values and heat quantities.

2. The ground information processing method according to claim 1, wherein the data analysis means stores detected data transmitted from the exploration communication section and performs quality evaluation on the detected data transmitted from the exploration communication section, based on data quality evaluation standards that are preset about magnitude of noise and a relationship between frequencies and phase velocities.

3. The ground information processing method according to claim 2, wherein the data analysis means transmits via an analysis communication section to the surface wave exploration means description, as instruction data, to prompt resurvey of the ground if the detected data is of an improper quality and description to prompt ending of survey if the detected data is of a proper quality.

4. An earth resources system for performing heat exchange by using ground heat, wherein system design is performed by using an absorbed/released unit heat quantity obtained by the ground information processing method according to claim 1.

5. An earth resources system for performing heat exchange by using ground heat, wherein system design is performed by using an absorbed/released unit heat quantity obtained by the ground information processing method according to claim 2.

6. An earth resources system for performing heat exchange by using ground heat, wherein system design is performed by using an absorbed/released unit heat quantity obtained by the ground information processing method according to claim 3.

7. The earth resources system according to claim 4, comprising:
a subsurface heat exchange section provided below ground where the system is installed; a heat pump connected to the subsurface heat exchanger and installed on an earth surface; a brine circuit that is connected between an heat exchanger on the condensation side of the heat pump and the subsurface hear exchanger and has a pump to circulate a mixed solution, which serves as a fluid medium, of water and an anti-freeze liquid between the heat exchanger and the subsurface hear exchanger; stock means for stocking the mixed solution; and a circuit that is connected between a heat exchanger on the evaporation side of the heat pump and the stock means and has a pump to circulate the mixed solution in the stock means between the hear exchanger and the stock means.

8. The earth resources system according to claim 5, comprising:
a subsurface heat exchange section provided below ground where the system is installed; a heat pump connected to the subsurface heat exchanger and installed on an earth surface; a brine circuit that is connected between an heat exchanger on the condensation side of the heat pump and the subsurface hear exchanger and has a pump to circulate a mixed solution, which serves as a fluid medium, of water and an anti-freeze liquid between the heat exchanger and the subsurface hear exchanger; stock means for stocking the mixed solution; and a circuit that is connected between a heat exchanger on the evaporation side of the heat pump and the stock means and has a pump to circulate the mixed solution in the stock means between the hear exchanger and the stock means.

9. The earth resources system according to claim 6, comprising:
a subsurface heat exchange section provided below ground where the system is installed; a heat pump connected to the subsurface heat exchanger and installed on an earth surface; a brine circuit that is connected between an heat exchanger on the condensation side of the heat pump and the subsurface hear exchanger and has a pump to circulate a mixed solution, which serves as a fluid medium, of water and an anti-freeze liquid between the heat exchanger and the subsurface hear exchanger; stock means for stocking the mixed solution; and a circuit that is connected between a heat exchanger on the evaporation side of the heat pump and the stock means and has a pump to circulate the mixed solution in the stock means between the hear exchanger and the stock means.

10. Aground information processing system comprising:
surface wave exploration means for surveying a condition of ground nondestructively; and
data analysis means for analyzing an S-wave velocity structure of the ground based on detected data obtained by the surface wave exploration means and utilizing, as a heat source, ground heat of the ground based on the analyzed S-wave velocity structure,
wherein the data analysis means comprises an S-wave analysis section for analyzing an S-wave velocity structure from the detected data obtained by the surface wave exploration means, a soil phase/N-value decision section for identifying a soil phase distribution and an N-value distribution of the ground based on an S-wave velocity structure analyzed by the S-wave analysis section, a heat quantity analysis section for estimating an absorbed/released unit heat quantity of the ground, which provides a parameter, based on the soil phase distribution and the N-value distribution identified by the soil phase/N-value decision section, and display means for displaying at least a result of analysis by the heat quantity analysis section.

11. The ground information processing system according to claim 10, wherein the data analysis means comprises a data quality evaluation section for evaluating a quality of detected data obtained by the surface wave exploration means.

12. The ground information processing system according to claim 11, wherein the data analysis means comprises an analysis storage section for storing at least one of detected data obtained by the surface wave exploration means, a result of analysis by the S-wave analysis section, a result of identification by the soil phase/N-value decision section, a result of estimate by the heat quantity analysis section, and a result of quality evaluation by the data quality evaluation section.

13. The ground information processing system according to claim 10, wherein the surface wave exploration means comprises:
vibration application means for applying vibrations to the ground; vibration reception means for receiving vibrations generated on the ground by the vibration application means; an exploration storage section for storing detected data about vibrations received by the vibration reception means; and an exploration communication section for transmitting the detected data stored in the exploration storage section to the data analysis means and receiving data of an instruction which prompts resurvey and ending of survey, the instruction data being transmitted from the data analysis means.

14. The ground information processing system according to claim 11, wherein the surface wave exploration means comprises:
vibration application means for applying vibrations to the ground; vibration reception means for receiving vibrations generated on the ground by the vibration application means; an exploration storage section for storing detected data about vibrations received by the vibration reception means; and an exploration communication section for transmitting the detected data stored in the exploration storage section to the data analysis means and receiving data of an instruction which prompts resurvey and ending of survey, the instruction data being transmitted from the data analysis means.

15. The ground information processing system according to claim 12, wherein the surface wave exploration means comprises:
vibration application means for applying vibrations to the ground; vibration reception means for receiving vibrations generated on the ground by the vibration application means; an exploration storage section for storing detected data about vibrations received by the vibration reception means; and an exploration communication section for transmitting the detected data stored in the exploration storage section to the data analysis means and receiving data of an instruction which prompts resurvey and ending of survey, the instruction data being transmitted from the data analysis means.

16. The ground information processing system according to claim 15, wherein the data analysis means comprises an analysis communication section for receiving detected data transmitted via the exploration communication section from the surface wave exploration means and transmitting the instruction data to the surface wave exploration means via the exploration communication section.

17. The ground information processing system according to claim 10, wherein the earth resources system comprises:
a subsurface heat exchange section provided below the ground where the earth resources system is installed; a heat pump connected to the subsurface heat exchanger and installed on an earth surface; a brine circuit that is connected between an heat exchanger on the condensation side of the heat pump and the subsurface hear exchanger and has a pump to circulate a mixed solution, which serves as a fluid medium, of water and an anti-freeze liquid between the heat exchanger and the subsurface hear exchanger; stock means for stocking the mixed solution; and a circuit that is connected between a heat exchanger on the evaporation side of the heat pump and the stock means and has a pump to circulate the mixed solution in the stock means between the hear exchanger and the stock means.

18. The ground information processing system according to claim 11, wherein the earth resources system comprises:
a subsurface heat exchange section provided below the ground where the earth resources system is installed; a heat pump connected to the subsurface heat exchanger and installed on an earth surface; a brine circuit that is connected between an heat exchanger on the condensation side of the heat pump and the subsurface hear exchanger and has a pump to circulate a mixed solution, which serves as a fluid medium, of water and an anti-freeze liquid between the heat exchanger and the subsurface hear exchanger; stock means for stocking the mixed solution; and a circuit that is connected between a heat exchanger on the evaporation side of the heat pump and the stock means and has a pump to circulate the mixed solution in the stock means between the hear exchanger and the stock means.

19. The ground information processing system according to claim 12, wherein the earth resources system comprises:
a subsurface heat exchange section provided below the ground where the earth resources system is installed; a heat pump connected to the subsurface heat exchanger and installed on an earth surface; a brine circuit that is connected between an heat exchanger on the condensation side of the heat pump and the subsurface hear exchanger and has a pump to circulate a mixed solution, which serves as a fluid medium, of water and an anti-freeze liquid between the heat exchanger and the subsurface hear exchanger; stock means for stocking the mixed solution; and a circuit that is connected between a heat exchanger on the evaporation side of the heat pump and the stock means and has a pump to circulate the mixed solution in the stock means between the hear exchanger and the stock means.

20. The ground information processing system according to claim 13, wherein the earth resources system comprises:
a subsurface heat exchange section provided below the ground where the earth resources system is installed; a heat pump connected to the subsurface heat exchanger and installed on an earth surface; a brine circuit that is connected between an heat exchanger on the condensation side of the heat pump and the subsurface hear exchanger and has a pump to circulate a mixed solution, which serves as a fluid medium, of water and an anti-freeze liquid between the heat exchanger and the subsurface hear exchanger; stock means for stocking the mixed solution; and a circuit that is connected between a heat exchanger on the evaporation side of the heat pump and the stock means and has a pump to circulate the mixed solution in the stock means between the hear exchanger and the stock means.

21. The ground information processing system according to claim 14, wherein the earth resources system comprises:
a subsurface heat exchange section provided below the ground where the earth resources system is installed; a heat pump connected to the subsurface heat exchanger and installed on an earth surface; a brine circuit that is connected between an heat exchanger on the condensation side of the heat pump and the subsurface hear exchanger and has a pump to circulate a mixed solution, which serves as a fluid medium, of water and an anti-freeze liquid between the heat exchanger and the subsurface hear exchanger; stock means for stocking the mixed solution; and a circuit that is connected between a heat exchanger on the evaporation side of the heat pump and the stock means and has a pump to circulate the mixed solution in the stock means between the hear exchanger and the stock means.

22. The ground information processing system according to claim 15, wherein the earth resources system comprises:
a subsurface heat exchange section provided below the ground where the earth resources system is installed; a heat pump connected to the subsurface heat exchanger and installed on an earth surface; a brine circuit that is connected between an heat exchanger on the condensation side of the heat pump and the subsurface hear exchanger and has a pump to circulate a mixed solution, which serves as a fluid medium, of water and an anti-freeze liquid between the heat exchanger and the subsurface hear exchanger; stock means for stocking the mixed solution; and a circuit that is connected between a heat exchanger on the evaporation side of the heat pump and the stock means and has a pump to circulate the mixed solution in the stock means between the hear exchanger and the stock means.

23. The ground information processing system according to claim 16, wherein the earth resources system comprises:
a subsurface heat exchange section provided below the ground where the earth resources system is installed; a heat pump connected to the subsurface heat exchanger and installed on an earth surface; a brine circuit that is connected between an heat exchanger on the condensation side of the heat pump and the subsurface hear exchanger and has a pump to circulate a mixed solution, which serves as a fluid medium, of water and an anti-freeze liquid between the heat exchanger and the subsurface hear exchanger; stock means for stocking the mixed solution; and a circuit that is connected between a heat exchanger on the evaporation side of the heat pump and the stock means and has a pump to circulate the mixed solution in the stock means between the hear exchanger and the stock means.
